(19) United States
(12) Patent Application Publication
(10) Pub. No.: US 2006/0110953 A1
(43) Pub. Date: May 25, 2006

(54) Automatic positioner for aligning a leadless electronic component within a test socket

(76) Inventor: Thomas A. Allsup, Dallas, TX (US)

Correspondence Address: WILLIAM A. FIETZ, 1024 E. LARRABEE STREET, APT F, SANTA MARIA, CA, 93455, US

(21) Appl. No.: 10/994,897

(22) Filed: Nov. 22, 2004

(51) Int. Cl. H01R 12/00

(52) U.S. Cl. 439/71

(57) ABSTRACT

An automatic positioner within a test or burn-in socket for aligning leadless electronic devices is disclosed. Four possible embodiments of the positioner are shown, each with clamshell and open top socket bodies for the latching mechanism to hold the device in place throughout the test and burn-in process.

### CROSS REFERENCE TO RELATED APPLICATIONS

Not Applicable

### FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Background—Field of Invention

This invention relates to making interconnections between electronic components, especially microelectronic components and, more particularly, to providing techniques for making temporary connections for semiconductor packages to circuit boards.

2. Background—Description of Prior Art

When a semiconductor manufacturer develops a new electronic device, it is subjected to a series of tests prior to production release. A common way to accelerate these qualification tests is to operate the device in a high temperature chamber. This testing at high temperatures is known as burn-in. During some qualification testing, certain electronic devices exhibit a high rate of infant mortality. Infant mortality refers to the early-life failures often observed in the “bath tub” shape statistical distribution of failures versus time. Devices of this type can usually be expected to function for years if they survive the initial hours of operation. When necessary, production lots can be screened for early failures by subjecting the devices to burn-in.

It is possible to solder the devices directly to a PCB and remove the devices after the burn-in but this is time-consuming, costly and potentially damaging to the device. A burn-in socket forms a temporary mechanical “nest” to hold the device and provide electrical contact during burn-in without damaging it.

There are many standard semiconductor package styles, each with a unique socket type and interconnection mechanism. Each package has dimensions that can vary from one manufacturer to another, and within each run of devices there may be piece to piece variation within Joint Electronic Device Engineering Council (JEDEC) specifications. As more and more contacts may be added and devices become more complex, precise positioning is more important, especially for test and burn-in. In that case, one would need to be able to accommodate more variation than, for example, in a manufacturing line where quite a number of pieces from the same supplier would be installed during a particular shift.

Various burn-in board sockets have been designed to accept the IC devices. However, as the distance between contacts, the pitch, tightens it becomes the same magnitude as the tolerance of fixed size nests so some form of compliance for dimensional variation may be necessary.

Objects and Advantages

It is an object of the present invention to provide a means of assuring that the device will be centered in the test and burn-in socket in the two dimensions of the plane of the contacts regardless of size variation, within certain limits.

It is a further object of the present invention to provide a means of assuring that the device will be centered in the test and burn-in socket regardless of any skewing that occurs during insertion.

It is another object of the present invention to maintain the position of the device throughout the test and burn-in period.

### BRIEF SUMMARY OF THE INVENTION

The present invention is envisioned as falling into one of four different embodiments, all of which achieve the same result by somewhat different means. In each case the device is placed in approximate position either manually or by a robot. Following its placement, a clamping device applies a downward pressure as lateral positioning devices move the device in two dimensions to its final centered test position, determined by the lateral positioning devices.

One embodiment has centering blocks that are pivoted so they move in a vertical plane, although the movement to center the DUT is so slight that their movement is essentially in a horizontal plane. The centering blocks are spring loaded and are held back away from the DUT for its insertion and removal.

Another embodiment is a rack and pinion arrangement where four mutually perpendicular racks are moved simultaneously by a single pinion. Four positioning blocks are attached to each of their respective racks and move in and out at equal rates until contact is made with all four sides of the device under test (DUT). At this point the DUT is centered and further downward pressure may be applied to ensure electrical contact with the test leads.

In another embodiment, instead of a rack and pinion arrangement, the centering blocks are pivoted so they swing in a horizontal plane and are spring loaded against the DUT. Insertion of the DUT is enabled by a mechanism that retracts the centering blocks against the spring tension to allow insertion. A further mechanism is included to apply a downward pressure to enable electrical contact.

Finally, the fourth embodiment comprises a moveable frame that can be pressed down to open the centering blocks and released to provide the centering force. This movement is achieved by means of four rack and pinion sets, a “multi-rack”, wherein the pinions are attached to the centering blocks and the racks are attached to the frame mentioned previously and move vertically.

More details of the four embodiments will be apparent from the figures and the detailed description.

### BRIEF DESCRIPTION OF THE DRAWINGS

FIG. 1 is a perspective showing the relationship among the DUT, the centering blocks and a mechanism for centering the device in one embodiment.

FIG. 2 shows the embodiment of FIG. 1 contained in a clamshell test socket.

FIG. 3 shows the embodiment of FIG. 1 contained in an open top test socket

FIG. 4 shows an embodiment wherein four racks are moved simultaneously by one pinion to center the device.

FIG. 5 shows the embodiment of FIG. 4 contained in a clamshell test socket.

FIG. 6 shows the embodiment of FIG. 4 contained in an open top test socket

FIG. 7 shows an embodiment wherein the centering blocks are pivoted in a horizontal plane.

FIG. 8 shows the embodiment of FIG. 7 contained in a clamshell test socket.

FIG. 9 shows the embodiment of FIG. 7 contained in an open top test socket

FIG. 10 shows an embodiment wherein the centering blocks are attached to a pinion and pivot in a vertical plane. A downward motion of a rectangular frame serves to move the centering blocks by means of four attached racks, or “multi-rack”, and pinion assemblies.

FIG. 11 shows the embodiment of FIG. 10 contained in a clamshell test socket.

FIG. 12 shows the embodiment of FIG. 10 contained in an open top test socket

### DETAILED DESCRIPTION OF THE INVENTION

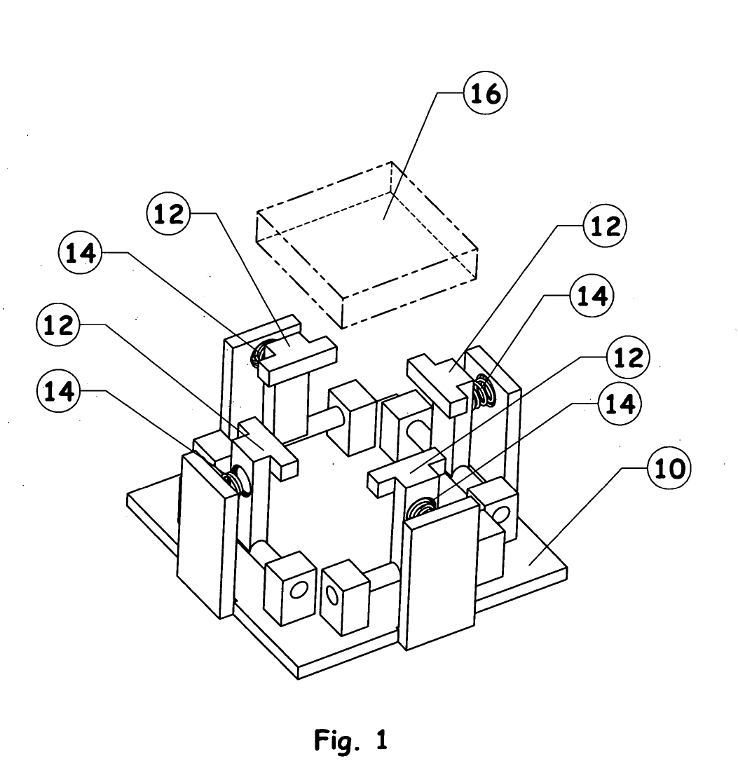

FIG. 1 shows a mechanism used to center the device 16 in one embodiment of the invention. The four centering pads 12 are spring loaded by compression springs 14 so that an equal pressure is exerted on each of the four sides of the device. During insertion and removal these pads are held back away from the device under test (DUT), and released to hold the DUT in proper position while testing. The entire assemblage is attached to a base 10 which in turn supports the test socket.

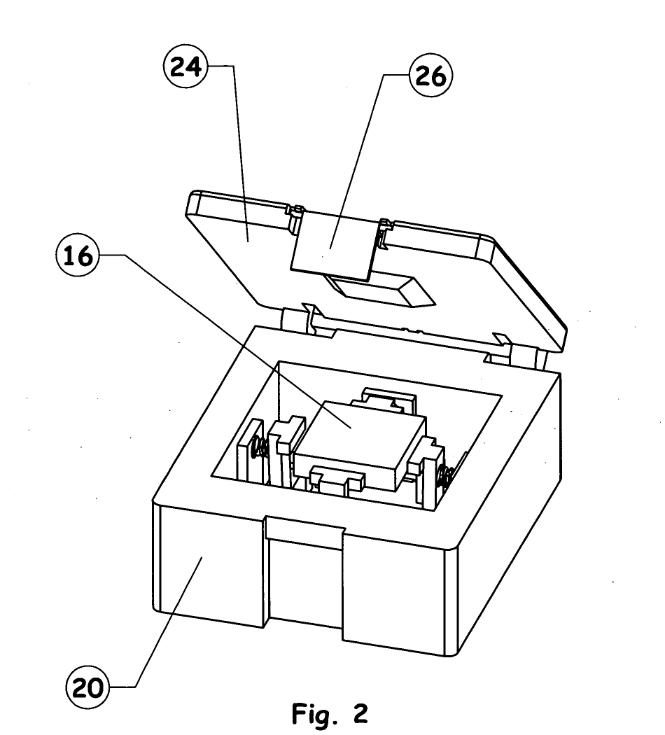

FIG. 2 shows the mechanism in what is called a clamshell test socket. The base 20 is a receptacle which supports the associated electrical testing contacts, (not shown here). A hinged cap 24 can be opened for insertion and removal of the DUT. When the cap is fully open, it engages the centering blocks to pull them away from the device. When the cap is closed, the blocks are released and the spring pressure centers the DUT accurately within the test socket. Upon complete closure, the latch 26 holds the cap in place and provides a downward pressure on the testing contacts to provide adequate electrical contact.

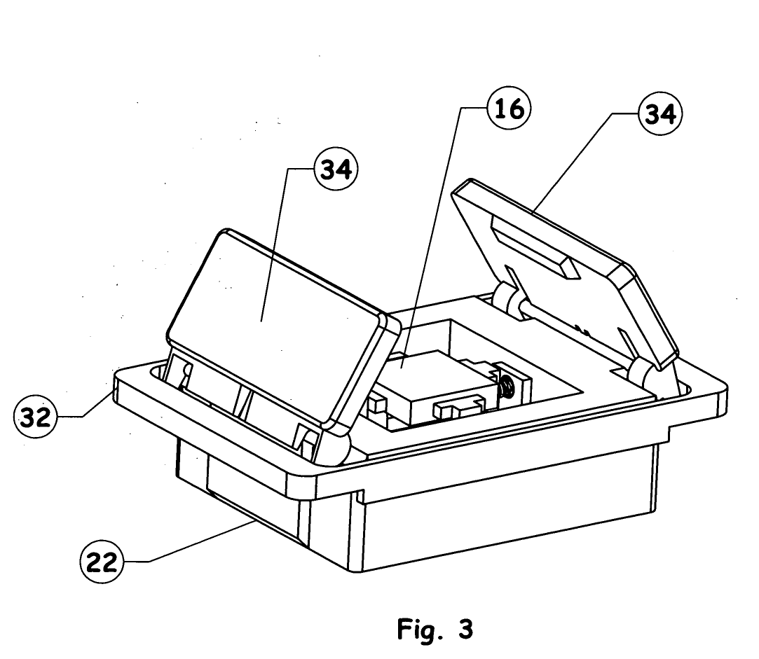

FIG. 3 shows another type of test socket incorporating the mechanism of FIG. 1, known as an open top socket. The base 22 is a receptacle that supports the associated electrical testing contacts, (not shown here). The open top provides heat transfer to the ambient environment through the top of the DUT since the flappers 34 holding the DUT only engage a small region of the top of the device. The flappers 34 are operated by a pusher 32 which latches in place when pressed downward. Pusher 32 also is connected to the centering blocks, releasing them for testing and pulling them back out of the way for insertion and removal.

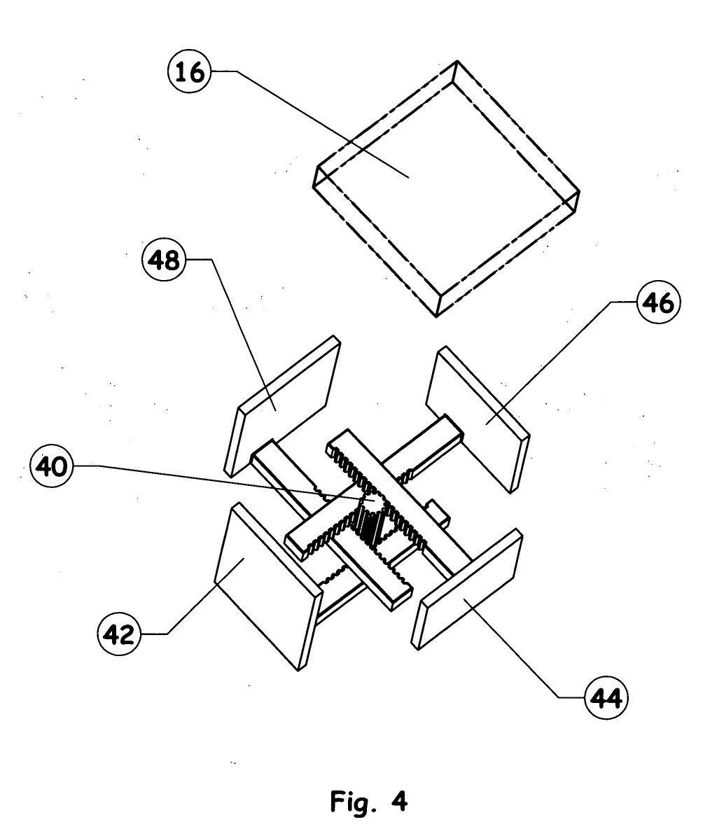

A second embodiment of a method for centering the device for testing using a multiple rack and single pinion assemblage, is shown in FIG. 4. In this embodiment a single pinion gear 40 operates four individual racks 42, 44, 46, and 48 to provide the centering action. Although as shown, the mechanism appears to be designed for square-devices, it is readily apparent that rectangular devices of other aspect ratios can be accommodated either by altering the registration of the racks with the pinion or by providing a different thickness of centering blocks 42-48. Since the racks move simultaneously by the same amounts, it can be readily seen that the device will be centered in two dimensions.

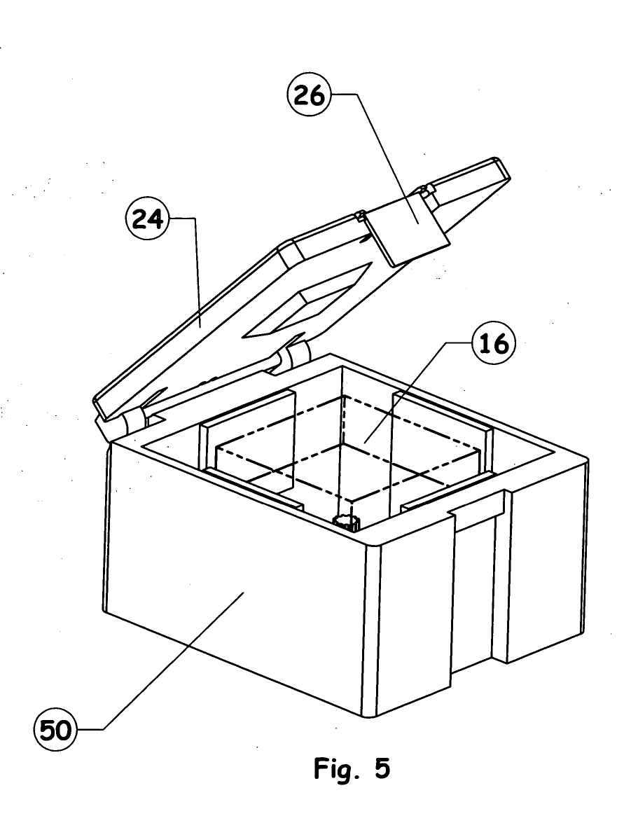

FIG. 5 shows this rack and pinion assemblage enclosed in a clamshell test socket. Again the cap 24 and latch 26 serve the function of holding the DUT in position when the cap is closed and latched to the base 50.

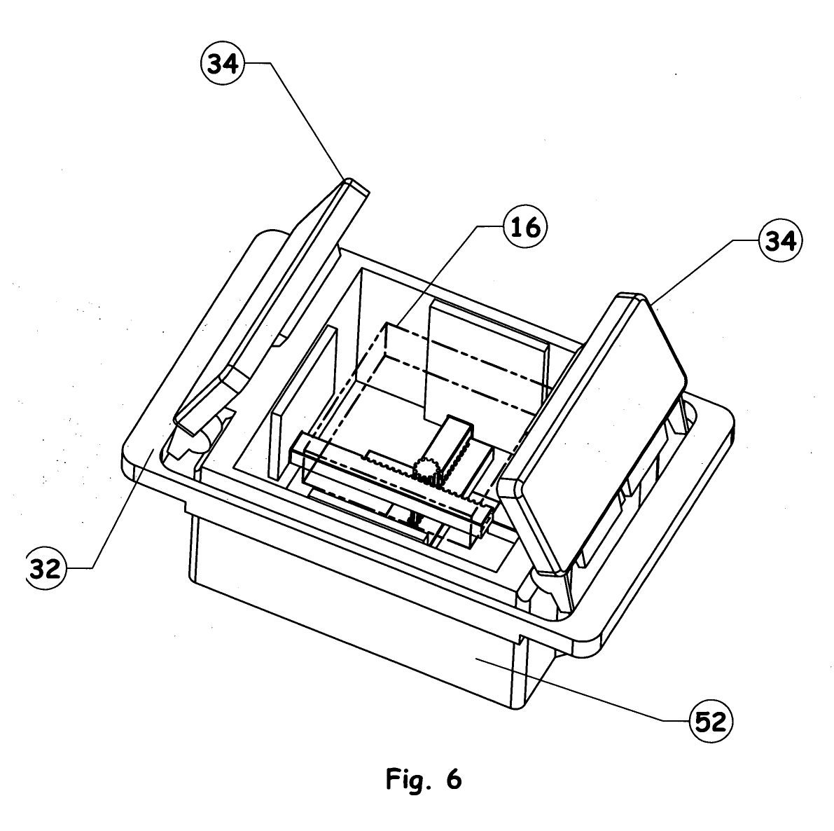

The rack and pinion assemblage of FIG. 4 is adaptable to an open top test socket as shown in FIG. 6. In this case the components play the same role, flappers 34 engage the DUT along the edges to provide contact pressure and pusher 32 activates the assemblage against the base 52.

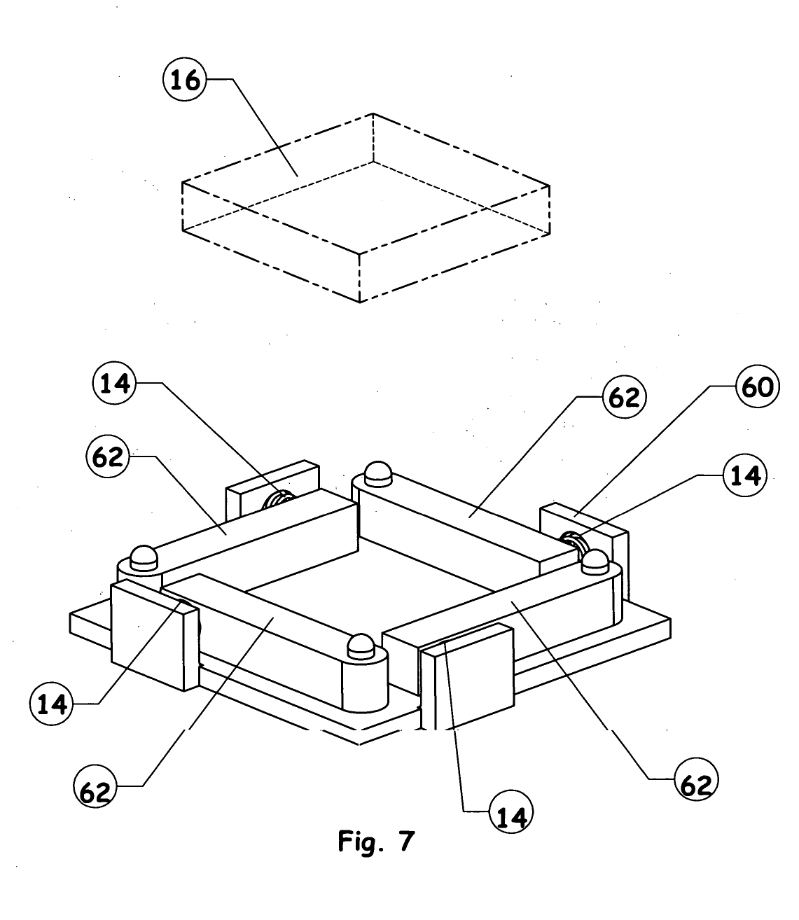

Still another mechanism for achieving accurate centering of the DUT is shown in FIG. 7. The arms 62 pivot in a horizontal plane and center the DUT by means of pressure from the compression springs 14 acting against backing plate 60

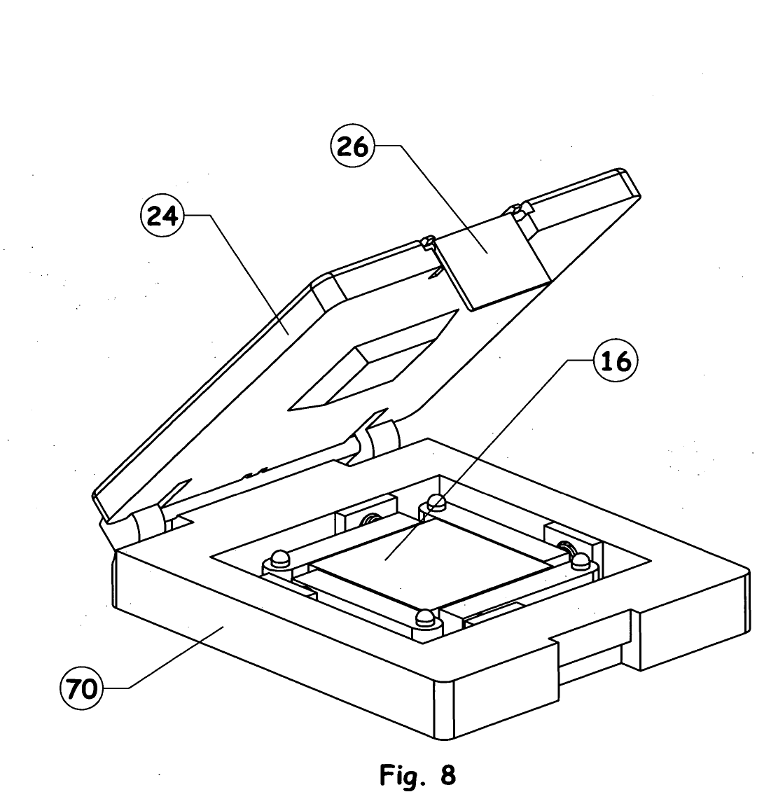

The mechanism of FIG. 7 is shown in a clamshell test socket in FIG. 8. In this embodiment the clamshell cap 24 and latch 26 provide the vertical support for the DUT against the base 70 while the mechanism centers the DUT.

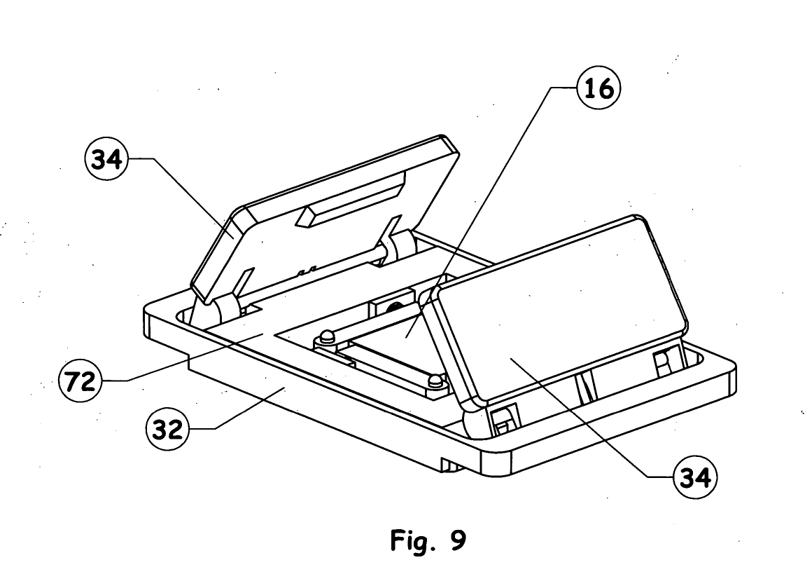

In FIG. 9 the mechanism of FIG. 7 is incorporated into an open top test socket. As in the prior open top embodiments, the pusher 32 serves to open and close the flappers 34, and the entire assemblage is attached to base 72.

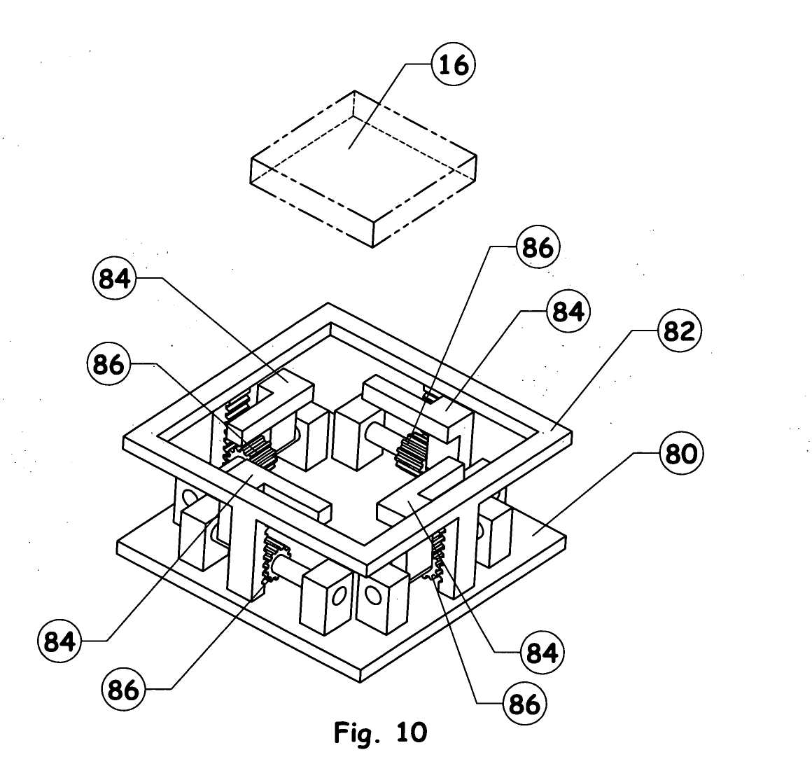

FIG. 10 shows a fourth technique for providing the desired centering of the DUT. In this embodiment a multi-rack assemblage 82 is designed to move vertically, supported by base 80 which guides the racks. As this multi-rack assemblage moves up and down, pinion gears 86 rotate. Since the pinion gears are firmly attached to centering blocks 84, the up and down movement of pusher 82 causes centering blocks 84 to move in and out to grasp and center the DUT.

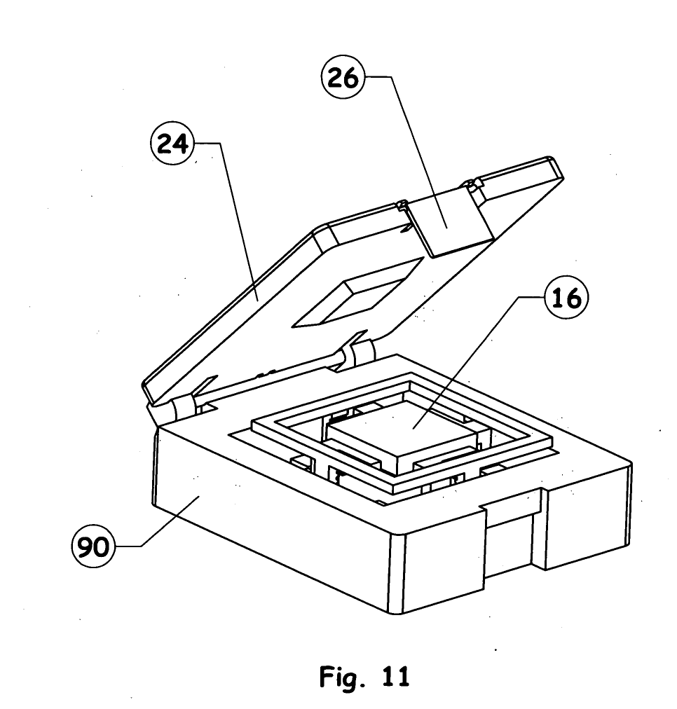

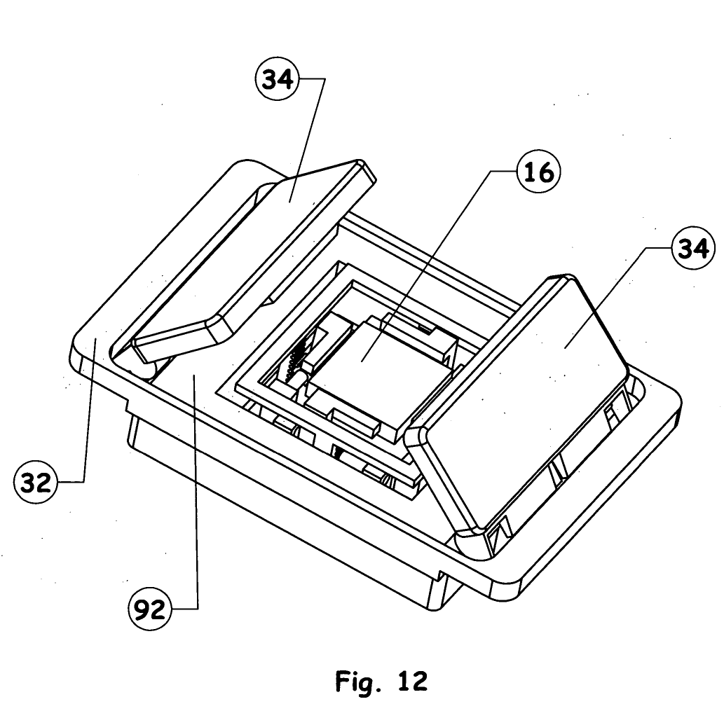

As in the previous embodiments of the centering mechanism, this one can be incorporated in a clamshell base 90 or open top test socket base 92 as shown in FIGS. 11, and 12 respectively.

Four different centering techniques have been shown incorporated in two different types of test socket bodies. Other methods and variations of the methods presented here may become apparent to one skilled in the art. One such variation is the replacement of the compression springs with torsion or cantilever beam springs in all embodiments. Another possible variation is the mechanism to hold back the centering pads, not shown in these figures, may be a screw, an inclined plane, a cam, or by some other method in all embodiments. Yet another possible variation is that the automatic positioner mechanism may be activated by the lid of the clamshell or pusher in the open top or it may be separately activated through a lever arm, knob, or other means. This disclosure is not intended to be limiting and exclusive, but should include all the obvious variations.

I claim:

1. A device centering socket assembly for test and burn-in of a leadless electronic device comprising:
An outer container for housing the entire assemblage,
a plurality of centering blocks,
a mechanism to operate said centering blocks, and
a means allowing insertion and removal of a leadless electronic device.

2. The assembly of claim 1 wherein said mechanism comprises a plurality of vertically pivoting spring loaded arms carrying said centering blocks.

3. The assemblage of claim 1 wherein said mechanism comprises a multiple rack and single pinion system.

4. The assemblage of claim 1 wherein said mechanism comprises a plurality of horizontally pivoting spring loaded arms carrying said centering blocks.

5. The assemblage of claim 1 wherein said mechanism comprises a plurality of vertically pivoting arms each rotated by a multi-rack, and pinions affixed to said centering blocks.

6. The assemblage of claim 1 wherein said mechanism comprises a multiple rack and single pinion system and said means for insertion and removal comprises a clamshell test socket body.

7. The assemblage of claim 1 wherein said mechanism comprises a multiple rack and single pinion system and said means for insertion and removal comprises an open top test socket body.

8. The assemblage of claim 1 wherein said mechanism comprises a plurality of vertically pivoting spring loaded arms carrying said centering blocks and said means for insertion and removal comprises a clamshell test socket body.

9. The assemblage of claim 1 wherein said mechanism comprises a plurality of horizontally pivoting spring loaded arms carrying said centering blocks and said means for insertion and removal comprises a clamshell test socket body.

10. The assemblage of claim 1 wherein said mechanism comprises a plurality of horizontally pivoting spring loaded arms carrying said centering blocks and said means for insertion and removal comprises an open top test socket body.

11. The assemblage of claim 1 wherein said mechanism comprises a plurality of vertically pivoting arms each rotated by a multi-rack, and pinions affixed to said centering blocks and said means for insertion and removal comprises a clamshell test socket body.

12. The assemblage of claim 1 wherein said mechanism comprises a plurality of vertically pivoting arms each rotated by a multi-rack and pinions, and carrying said centering blocks and said means for insertion and removal comprises an open top test socket body.

13. A method for assuring proper placement of a leadless electronic device so as to align the electrical contacts on the device precisely with the test socket contacts comprising:
The use of:
An outer container for housing the entire assemblage,
a plurality of centering blocks,
a mechanism to operate said centering blocks, and
a means allowing insertion and removal of a leadless electronic device.

14. The method of claim 6 wherein said mechanism comprises a multiple rack and single pinion system.

15. The method of claim 6 wherein said mechanism comprises a plurality of vertically pivoting spring loaded arms carrying said centering blocks.

16. The method of claim 6 wherein said mechanism comprises a plurality of horizontally pivoting spring loaded arms carrying said centering blocks.

17. The method of claim 6 wherein said mechanism comprises a plurality of vertically pivoting arms each rotated by a multi-rack, and pinions affixed to said centering blocks.
